(19) United States
(12) Patent Application Publication
(10) Pub. No.: US 2024/0262049 A1
(43) Pub. Date: Aug. 8, 2024

(54) SOLID COMPOSITE SHAFT AND SOLID CORE FILAMENT WINDING

(71) Applicant: CCDI Composites, Inc., Santa Ana, CA (US)

(72) Inventors: Steven Koon Hung Sim, Placentia, CA (US); Richard Craig Olson, Waco, TX (US); Angel Barragan, Irvine, CA (US)

(73) Assignee: CCDI Composites, Inc., Santa Ana, CA (US)

(21) Appl. No.: 18/164,497

(22) Filed: Feb. 3, 2023

(51) Int. Cl. B29C 70/32; E21B 33/134

(52) U.S. Cl. CPC B29C 70/32; E21B 33/134; B29L 2031/75; F16C 2220/28

(57) ABSTRACT

A composite shaft or rod formed by filament winding. The composite shaft is a solid shaft and the filament winding does not involve a mandrel. A filament core can be suspended between rotatable spindles and the filament materials can be laid directly onto the filament spindle, without any mandrel. A plurality of payout eyes can be used to simultaneously lay filament materials onto the filament core. A bridge plug can be formed with the solid composite shaft located within the bridge plug shell of the bridge plug.

### FIELD OF ART

The present disclosure is generally directed to solid composite shafts or rods and solid core filament winding for forming solid composite shafts.

### BACKGROUND

Filament winding is a fabrication technique used for manufacturing hollow cylinders or shafts or closed end structures, such as pressure vessels or tanks. This process involves winding filaments under tension over a rotating mandrel, which then produces a hollow composite cylinder or shaft due to the presence of the rotating mandrel, and due to the removal of the mandrel from the composite winding. The mandrel rotates around the spindle while a delivery eye (also known as a payout head or payout eye) on a carriage traverses horizontally in line with the axis of the rotating mandrel to lay down strands of fibers in a desired pattern or angle to the rotational axis, typically of the hoop winding type or the helical winding type.

The most common filaments are glass or carbon and are impregnated with resin by passing through a bath as they are wound onto the mandrel. Alternatively, prepeg fibers, also known as pre-impregnated fibers, may be used. Once the mandrel is covered to the desired thickness with layers of the filament fibers laid down onto the rotating mandrel, the resin can be cured. Depending on the particular resin system used, the mandrel can either be autoclaved or heated in an oven or rotated under radiant heaters until the part is cured.

Once the resin has cured, the mandrel can be removed or extracted from the mandrel, leaving the hollow final product. For some products such as gas bottles, the ‘mandrel’ is a permanent part of the finished product forming a liner to prevent gas leakage or as a barrier to protect the composite from the fluid to be stored.

### SUMMARY

Aspects of the invention include a method for forming a composite rod or shaft. The method can comprise suspending roving strands between two spindles to form suspended roving strands that define a composite core; and winding roving materials through at least two payout eyes and then laying the roving materials around the composite core.

The method can further comprise adjusting a tension on the suspended roving strands prior to the winding step.

The at least two payout eyes can be located on a frame of an eye unit.

The eye unit can comprise a third payout eye located on the frame of the eye unit.

The payout eyes can be generally evenly spaced relative to one another.

The method can comprise winding a plurality of layers of roving materials around the filament core to a desired diameter to form a composite shaft or rod. The composite shaft or rod can be solid and can be formed via filament winding without using a mandrel.

A further aspect of the invention includes a filament winding apparatus or machine comprising two spindles and at least one tensioner. The at least one tensioner is configured to adjust the tension on the suspended roving strands, which form the filament core of the invention without a mandrel.

The filament winding apparatus can further include an eye unit comprising at least two payout eyes. The eye unit can accommodate the filament core therein and the at least two payout eyes can direct at least two different sets of roving materials therethrough to deposit the roving materials onto the filament core, without a mandrel.

The eye unit can further include a plurality of winding arms. Each winding arm can have at least one payout eye.

A still further aspect of the invention is a solid composite shaft or core formed by filament winding without a mandrel.

A further aspect of the invention comprises a preform comprising a solid composite shaft and a composite shell wound around an exterior of the solid composite shaft.

Yet, a still further aspect of the invention comprises a bridge plug frame comprising a solid composite shaft and a composite shell located around an exterior of the solid composite shaft, a first bore at a first end of the bridge plug frame, and a second bore at a second end of the bridge plug frame; and wherein each of the first bore and the second bore comprises a ball seat having a surface formed by both the solid composite shaft and the composite shell.

The bridge plug frame can further comprise at least one machined portion and wherein bridge plug components can be located at the at least one machined portion.

The present invention further includes a method of forming a bridge plug comprising forming a composite solid shaft without a mandrel; and locating the composite solid shaft within a composite bridge plug shell.

The composite shell can be wound directly around the solid shaft or can be formed first and then the solid shaft inserted into a hollow bore of the composite shell.

The method can further comprise placing bridge plug components onto the bridge plug shell.

The bridge plug components can include a slip ring and a slip wedge.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic side view of a filament winding apparatus provided in accordance with aspects of the invention.

FIG. 2 is schematic side view of two modified spindles for suspending roving strands to form a filament core in accordance with aspects of the invention.

FIG. 3 is a schematic side view of two modified spindles for suspending roving strands to form a filament core in accordance with aspects of the invention, similar to FIG. 2 but wherein the strands are twisted.

FIG. 4 is a schematic ring payout eye unit or system containing a plurality of payout eyes for simultaneously winding several sets of roving materials around a filament core.

FIG. 5 is a schematic ring payout eye unit or system containing a plurality of payout eyes and having a plurality of roving material sets routed through the plurality of payout eyes for simultaneously winding several sets of roving materials around a filament core.

FIG. 6 is a schematic side view showing a filament core mounted between two spindles and at least two sets of roving strands are being laid onto the filament core in a helical winding pattern.

FIG. 7 is a schematic side view showing a filament core mounted between two spindles and at least two sets of roving strands are being laid onto the filament core in a helical winding pattern, similar to FIG. 6 but wherein the roving strands are twisted prior to the winding operation.

FIG. 8 is a side perspective view of a composite shaft or rod formed using the apparatus and method of the present invention.

FIG. 9 is a flow diagram depicting a process or method for forming a composite rod or shaft using filament winding without a mandrel.

FIG. 10 is a schematic cross-sectional side view of a composite preform comprising an inner composite shaft and an outer composite shell.

FIG. 11 is a schematic cross-sectional side view of a bridge plug frame formed from the composite preform of FIG. 10.

FIG. 12 is a schematic cross-sectional side view of a bridge plug provided in accordance with aspects of the invention.

### DETAILED DESCRIPTION

The detailed description set forth below in connection with the appended drawings is intended as a description of the presently preferred embodiments of solid composite shafts or rods, solid core filament winding for forming solid composite shafts, composite preform, composite bridge plug frame, and composite bridge plug provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

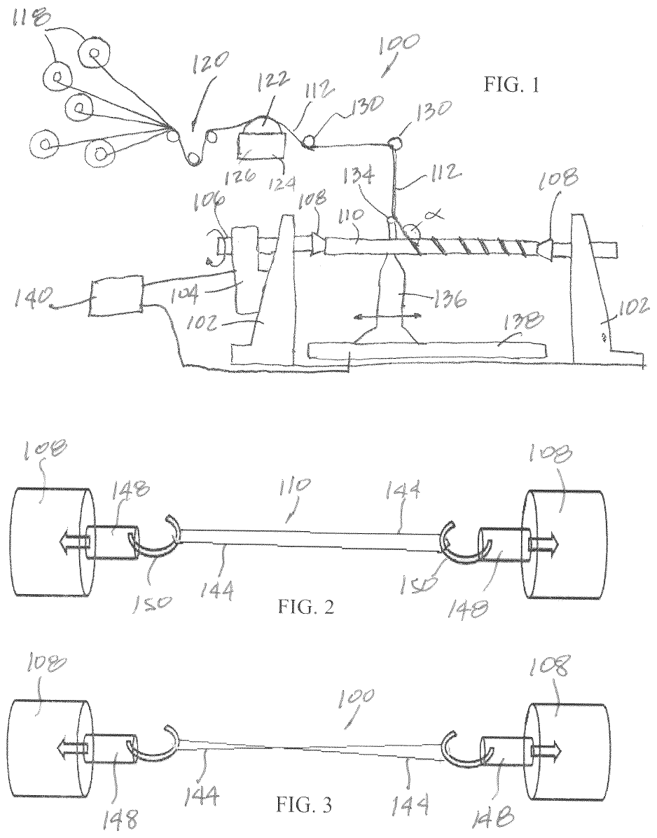

With reference now to FIG. 1, a filament winding apparatus 100 is shown schematically that is usable for core filament winding for forming solid composite shafts, with modifications to the rotating mechanism, as further discussed below. The filament winding apparatus 100 can include a frame 102 that supports a motor 104 configured to rotate an axle 106. Spindles 108 on the axle 106 can be configured to releasably hold a filament core 110 upon which a filament 112 may be wound to create a part such as a solid composite shaft 116 (see FIG. 8). A plurality of roving spools 118 can provide fibers to a tensioner 120, which combines fibers into a filament 112 that can be drawn over a resin drum 122 that rotates through a resin bath 124 located in a container or tub 126 so that the filament 112 becomes impregnated with epoxy resin. Further tensioners and re-directors 130 can direct the epoxy-impregnated filament 112 through a payout head or payout eye 134 that is carried by a carriage 136. The carriage 136 is supported on a track 138 and motorized so as to move back and forth generally parallel to the axle 106. The filament can be any conventional type configured for the intended purpose, such as carbon fiber, glass fiber, aramid fiber, and the resin can be any conventional type configured for the intended purpose, such as epoxy, polyurethane, polyester, vinyl ester, phenolics, furans, and polyimides.

As the axle 106 spins to spin the filament core 110, filament 112 accumulates on the filament core 110, forming layers of such filament 112. A winding angle α of each filament 112 as laid on the filament core 110 is determined by the rotational speed of the axle 106 and the translational speed of the carriage 136. Preferably, the motor 104 and the carriage 136 are electronically controlled by a programmable controller 140 so that the winding angle α, number of layers, etc., can be strictly controlled. As the present invention is directed to solid composite shafts or rods and solid core filament winding for forming solid composite shafts, the winding angle is limited primarily to helical winding type, in the order of about +/−5 degrees to 30 degrees relative to the axis defined by the filament core 110, although there is no prohibition against using larger angles for hoop winding type.

Once sufficient layers of filament of filament are laid onto the filament core 110 to form a solid rod or shaft and cured, it can be removed from the spindles 108 and machined if desired. It is also to be understood that, in some embodiments, the filament that is wound about the mandrel filament core 110 comprises many fibers, such as from the multiple roving spools 118, that can be compressed somewhat into a substantially flat tape that is wound about the filament core 110. Such filament tape 112 preferably is applied to the mandrel filament core 110 so that it is flat in a plane that is substantially parallel to the axis of the filament core 110. The number of roving spools 118 can be selected to simultaneously feed a plurality of payout eyes, as further discussed below. Roving strands that pass through a payout eye in an eye unit comprising a plurality of payout eyes can be referred to as a set of roving strands.

FIG. 2 is a schematic diagram showing a filament core 110 located between two spindles 108. As previously discussed, the present invention is directed to solid composite shafts or rods and solid core filament winding for forming solid composite shafts, which do not require the use of a rotating mandrel from which filament layers are laid. Instead, a filament core 110 is first provided on the filament winding apparatus 100 before depositing the filament layers thereon. This allows for a solid composite shaft or rod to be formed without a rotating mandrel.

In an exemplary embodiment, roving strands 144 are suspended between two spindles 108 to form a filament core 110 of the present invention. The filament core 110 then provides the foundation for which to lay filament fibers to form layers of fibers of a solid composite shaft or rod. As shown, one or both spindles 108 can be provided with a tensioner 148. Each tensioner 148 can be spring loaded, mechanically adjustable, and/or electronically adjustable based on stress/strain values indicative of the tension of the roving strands suspended by the one or two tensioners 148. The tensioners 148 are configured to maintain appropriate tension on the roving strands 144 for forming the filament core 110 of the present invention via filament winding around the filament core. In an example, the roving strands should be taunt when suspended so that the two rows of roving strands are generally parallel as they are suspended between the two spindles 108. In some examples, there can be more than two rows of roving strands mounted between the two spindles to form the filament core of the present invention. In yet other examples, the roving strands 144 can be taunt and functions as a filament core 110 without the need for any tensioner 148.

In an example, a mounting end 150 can be located on each tensioner 148 for supporting the roving strands 144 in two rows of elongated and parallel fibers. Optionally, more than two rows of fibers may be used to form the filament core of the present invention. The mounting end 150 can embody any number of shapes or structures, such as a hook shape, an eye-bolt, a C-clamp, etc., and is configured to provide physical support for the roving strands, to suspend the roving strands between the two spindles 108. That is, the roving strands can mechanically connect to the two mounting ends 150 to be suspended between the two spindles 108. Two ends of the roving strands can be tied or knotted to remain suspended between the two mounting ends 150.

Once the filament core 110 are formed as shown, filament layers can be deposited onto the filament core 110 in a helical winding pattern, without any rotating mandrel, to from a solid shaft or rod in accordance with aspects of the invention. In some embodiments, the roving strands 144 are first twisted to form a twisted filament core 110 before filament layers can be deposited thereon in a helical winding pattern, without a rotating mandrel, as shown in FIG. 3. The strands 144 can be twisted once as shown or several times by rotating one spindle relative to the other. The number of twists can comprise one or more, such as three or more up to the number of times that extend about the full length of the roving strands. For example, with just one twist, the filament core has a single reduced section generally midway of the filament core. With additional twists, the reduced section can be longer. For example, the two rows of roving stands 144 can be twisted more than ten times, such as about fifty times, to span a central section of the filament core 110. In another example, the two rows of roving strands 144 can be twisted more than fifty times, such as 100, 150, 200, or 250 times, or greater, to span a larger central section of the filament core 110, which is longer than the central section formed by 50 twists.

The two spindles 108 are preferably rotated in unison so as to turn the filament core 110 in a synchronous revolution. In an example, the two spindles 108 are directly mechanically engaged so as to rotate in unison by a single motor. For example, the two spindles can be geared and/or linked by a belt drive system in order to rotate in unison. In alternative embodiments, the two spindles 108 are motorized and are electronically controlled so as to rotate in unison. For example, the controller 140 (FIG. 1) can be programmed to synchronize the two motors that separate operate the two spindles 108. In yet other examples, a single can turn the two spindles when the filament core 110 is at relatively higher tension with little or no slack, thereby acting like a solid rod.

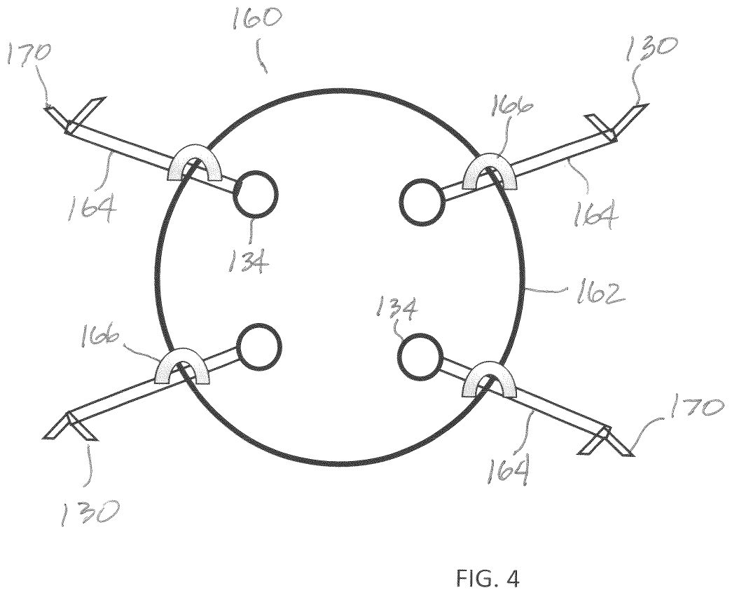

With reference now to FIG. 4, a schematic ring payout eye unit or system 160, or eye unit or system, is shown. The eye unit 160 is preferably used with the filament winding unit 100 to provide the winding unit 100 with multiple payout eyes for simultaneous laying of multiple sets of roving strands onto the filament core 110. For example, two or more independent sets of fiber layers can be laid onto the filament core 110 as the core rotates and the eye unit 160 translates along the axis of the filament core. The eye unit 160 preferably has two or more payout eyes or heads 134 equally spaced relative to one another so as to create axial symmetry about the filament core 110 to balance the load during winding of the fiber about the filament core.

In an example, the eye unit 160 comprises a frame 162 having two or more winding arms 164 attached to the frame, such as via a clamp, fastener, strap, and/or welding 166. The frame can embody any number of shapes, such as square or oval, with round or circle being more preferred. A payout eye or head 134 can be located at an end of each winding arm 164. The two or more payout eyes 134 can define a boundary for surrounding the rotating filament core 112 therein and for laying filament fibers thereon, as further discussed below. While as few as two payout eyes 134 can be incorporated with the eye unit 160, preferably the eye unit as three or more payout eyes 134 equally spaced along the periphery of the frame to form axial symmetry about the filament core 110 to ensure a balance load on the filament core during winding. Hooks or pin rings may be mounted on both ends of the rotating axis to allow the roving strands coming out of the payout eyes 134 to catch and build up the tooling from the fiber itself to create a solid part. In some examples, when fiber is wound onto the core 110 and typically during the beginning or start of the winding process, the eyes or mounting ends 150 (FIG. 2) are deliberately deposited or wound with filament fibers so that the fiber can catch on the hooks/pins to keep the fiber from sliding. After the parts are built up to a certain thickness, the friction around the filament 110 will allow the lay down fiber to stay on without sliding. At approximately that point, the winding can stop short of the two mounting ends 150 so that only the length between the two mounting ends 150 are laid up with layers.

In an example, each winding arm 164 can include a tensioner and/or re-director 130 for directing a corresponding epoxy-impregnated filament through the payout head or payout eye 134 at the opposite end of the winding arm. For example, a single resin bath can be used to coat the multiple roving strands that pass through the multiple payout eyes 134 on the eye unit 160 and the tensioner and/or re-director 130 can assist with routing the coated roving strands through the respective payout eye 134. In alternative examples, each winding arm 164 has an impregnation unit 170 mounted thereon or coupled therewith, which can include a resin bath contained in a reservoir and a tensioner and/or re-director 130 for directing a corresponding epoxy-impregnated filament through the payout head or payout eye 134. That is, each roving strand of the multiple roving strands to be routed through the eye unit 160 can pass through a dedicated resin bath located on the eye unit.

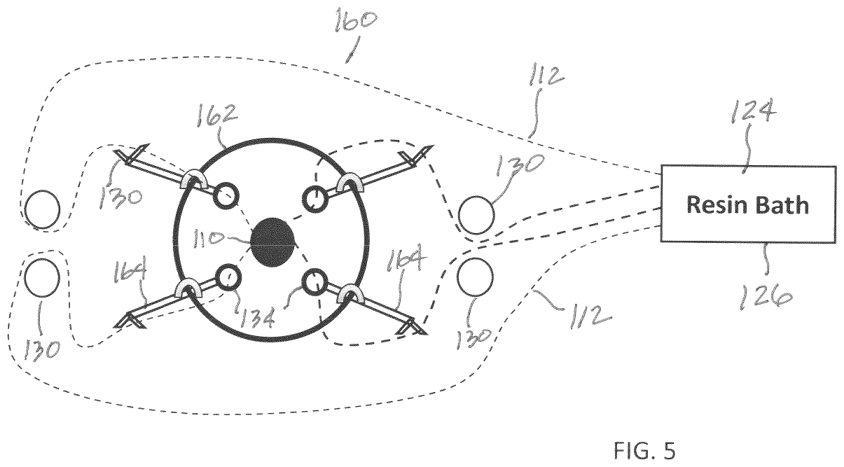

FIG. 5 is a schematic diagram depicting the eye unit 160 of FIG. 4 being used to wind multiple sets of filaments 112 around the filament core 110 to build up layers of filaments around the filament core 110 to a desired length and diameter or cross-sectional dimension. As shown, a plurality of roving strands or filaments 112 exit a resin bath 124 held in a tub or container 126, which can be the resin bath 124 shown in FIG. 1. The multiple roving strands or filaments 112 can then rout through tensioners and/or redirectors of respective winding arms 164 and respective payout eyes 134 on the eye unit 160 to simultaneously lay four sets of rovings 112 onto the filament core 110 to build up the filament core. The four payout eyes 134 are in axial symmetry relative to the filament core 110 to balance the load on the filament core to enable winding thereon without a solid mandrel.

While the eye unit 160 of FIG. 4 is shown with four payout eyes 134, the number can vary from as little as two, such as at least two, up to a practical number, such as around eight payout eyes. The payout eyes should be equally spaced apart from one another.

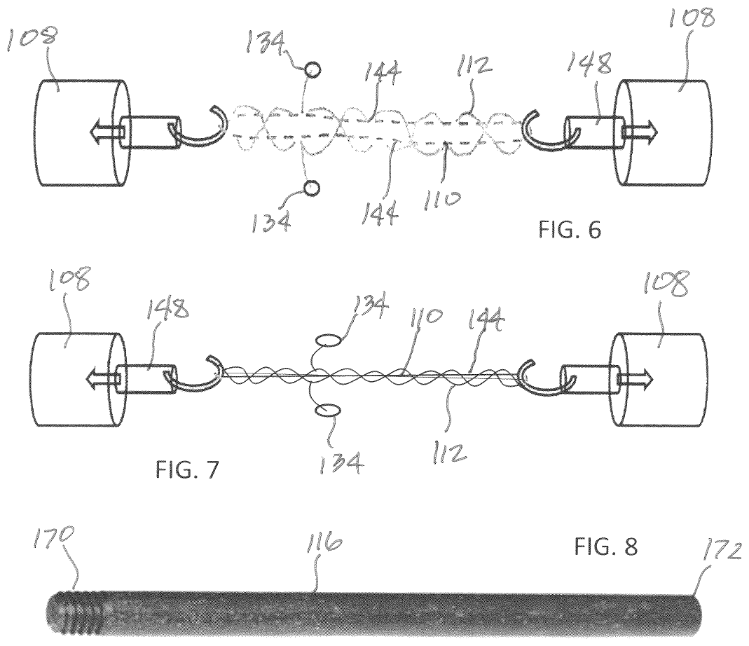

With reference now to FIG. 6, a side schematic view of the system of FIG. 5 is shown. As shown, the roving strands 144 forming the filament core 110 are suspended in parallel relation to one another. The filaments 112 from the multiple roving spools 118 are then laid on the filament core 110 in a helical winding pattern. In an example, the winding angle can start or begin at a relatively higher angle to enable wrapping and squeezing of the filament core 110 by the filament winding, for example 60 degrees to 85 degrees. Once the first few layers are laid down a sufficient amount to form a stiff filament core 110, the subsequent layers can be wound at smaller angles, such as about 5 degrees to about 45 degrees relative to the axis of the filament core 110, with about 5 degrees to about 15 degrees being more preferred. The winding angle can be determined by the rotational speed of the filament core 110, as determined by the rotational speed of the two spindles 108, and the translational speed of the carriage 136 in translating the eye unit 160 and therefore the payout eyes 134 along the axis of the filament core 110. While only two sets of roving materials 112 are shown laid on the filament core by two payout eyes 134 in a helical winding pattern, the system can simultaneously lay more than two sets of roving materials, such as three, four, five, six, seven, or eight sets of roving materials. The winding pattern can repeat with the filament core 110 rotated by the two spindles 108 while the payout eyes traverse back and forth by the carriage to lay a desired number of filament layers onto the filament core 110 to from a solid composite shaft having a desired diameter, built-up by the number of layers of roving materials deposited on the core. After winding the filament core 110 with sufficient filament layers to form a desired composite shaft diameter, the wound shaft can dry by hanging vertically by one end in an oven and then applying weight or placing the part to be dried in tension to keep it straight while curing.

FIG. 7 shows a side schematic view of the winding system of the present invention, similar to FIG. 6. However, in the present embodiment, the roving strands 144 are first twisted to from a filament core 110 with twisted strands. The number of twists can vary from one all the way up to one hundred, or even higher, as previously discussed.

FIG. 8 is a side perspective view of a solid composite shaft or rod 116 produced using the winding system and method of the present invention. As shown, the shaft 116 has been post-cured processed by cutting the length down to size and then machining one of the ends 170, such as by machining threads for threaded engagement. The opposite end 172 remains blunt or un-threaded. The composite shaft 116 is solid and is formed by winding roving materials around two rows of roving strands suspended between two spindles, without a supporting mandrel.

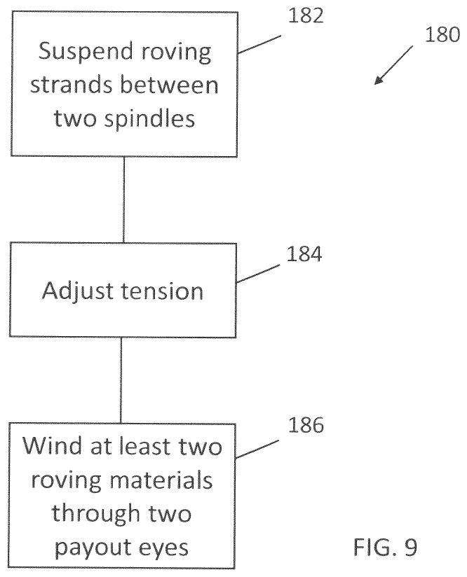

FIG. 9 is a schematic diagram depicting a process or method 180 for forming a composite rod or shaft using filament winding without a mandrel. At 182, the process comprises setting up the filament core of the present invention by suspending roving strands between two spindles. The roving strands can be suspended along at least two parallel rows. The suspended roving strands form the filament core of the present invention for forming a composite shaft or rod without a rotating mandrel.

At 184, the process continues by adjusting the tension or by twisting the core 110 of the suspended roving strands. The tension can be adjusted by any number of methods, including by adjusting a movable rod to control a gap or distance of the two ends of the roving strands and therefore the tension of the roving strands. The adjustment can include using a threaded adjustable knob, a threaded shaft, a spring, a lever, etc. The tension on the roving strands should cause the strands to be taunt.

Next, the process continues at 186 with winding at least two roving materials through two payout eyes to simultaneously wind the roving materials around the filament core formed at 184. The two payout eyes should be evenly spaced relative to one another to provide axial symmetry around the filament core. In other examples, the process can involve more than two sets of roving materials for use with more than two payout outs. The process can continue with winding a plurality of filament layers around the filament core to build up the core and produce a composite rod or shaft, without using a mandrel.

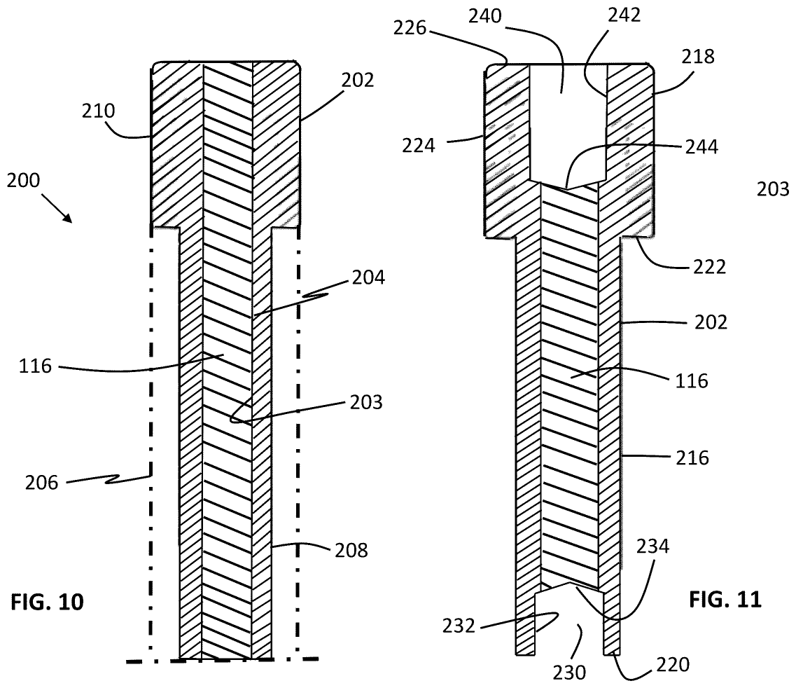

With reference now to FIG. 10, a composite preform assembly 200 is shown comprising an inner composite rod or shaft 116 and an outer composite shell 202, which has been formed over the composite rod or shaft 116 via filament winding. In an example, the inner composite shaft 116 has a length and a diameter and may be formed via the process and apparatus disclosed with reference to FIGS. 2-9. The composite shaft 116 can be wound to any desired length and diameter, as needed for the particular application and the winding machine used to wind the shaft. In a particular example, the composite shaft 116 is longer than a length of a down hole bridge plug and can be post-formed machined to final working dimension.

The shell 202 can be formed by winding filament fibers around the exterior 204 of the composite shaft 116. For example, after forming the composite shaft 116 and allowing the shaft to cure, the shaft 116 can then be used as a mandrel for winding fibers around the exterior 204 of the composite shaft to form the shell 202. Thus, the shell 202 can have an inner most layer 201 that contacts or is wound directly onto the exterior of the composite shaft 116. The inner most layer 201 forms the inside diameter of the shell 202.

The composite shell 202 is filament wound with slightly shorter as the length of the composite shaft 116. In an example, the composite shell 202 can be wound to approximately the same outer diameter 206 along the length of the shell. In another example, the composite shell 202 can be wound with at least two different outer diameter sections 208, 210. For example, the outer shell can have a first diameter section 208 and a second diameter section 210, which is larger than the first diameter section. The same outer diameter 206 or the largest second diameter section 210 of the shell can be selected based on the bridge plug application. In other examples, the length of the inner shaft 116 and the diameter and length of the shell 202 can be other than described and then machined down to size, as further discussed below.

The shell 202 is allowed to cure following formation around the inner shaft 116, preferably in a heated environment, such as in a temperature controllable oven. The curing time and temperature range are epoxy and thickness dependent, which those skilled in the art understand.

With reference now to FIG. 11, the preform 200 is then machined, such as with a lathe and/or a computer numerical control (CNC) machine to form the shape shown, which can embody a bridge plug frame 203. In an example, the shell 202 is machined to form a first machined section 216 and a second machined section 218, both with a length and a diameter. As shown, the first machined section 216 is machined to a desired outer diameter as needed for the bridge plug application. The length of the first machined section 216 measured from the lower end or first end 220 to the shoulder 222 located between the first and second machines sections is also application dependent and can vary as needed. The outer diameter of the first machined section 216 can be sized and shaped to accommodate components of a downhole bridge plug, as further discussed below. The second machined section 218 defines a head section 224, which has a diameter and a length measured from the upper end or second end 226 to the shoulder 222.

Internally at the first end 220, a bore 230, also referred to as a first bore, can be machined with a sidewall 232 and a bore bottom 234. The bore 230 can have an inside diameter that is smaller than a ball plug to be used with the bridge plug frame 203 and larger than 116, as further discussed below. In an example, the sidewall 232 of the bore 230 defines an inside diameter having a dimension of about 6 mils to about 30 mils smaller than the diameter of the ball plug with about 12 mils to 18 mils being preferred. The interference can depend on the hardness of the ball plug used. The hardness can depend on the application environment, such as pressure, temperature, and corrosive chemical present. In an example, the inside diameter of the bore 230 has a dimension that is larger than the outside diameter of the inner shaft 116. Thus, the bore bottom 234 is made up of both the end surface of the inner shaft and part of the shell. The bore bottom 234 defines a ball seat.

In an example, the bore bottom 234 can be machined with a conical or a frusto-conical cross-section, which forms a ball seat at the first end of the bridge plug frame 203. The conical or frusto-conical bottom or flat bottom allows the ball plug to seat against the ball seat and forms a circular line seal where the two contact.

A second bore or upper bore 240 is located at the opposite end of the bridge plug frame 203. In an example, the second bore 240 is shaped like the first bore 230. That is, the second bore 240 can be machined with a sidewall 242 and a bottom wall 244, which can have a conical or a frusto-conical shape or flat. The bottom wall 244 of the bore defines a ball seat. The bore bottom 244 is made up of both the end surface of the inner shaft and part of the shell. In some examples, a small through bore may be machined through the center of the inner shaft 116.

In another exemplary embodiment, the shell 202 may be formed over a traditional mandrel and then separate from the mandrel when cured. The mandrel may be selected to have an outer diameter that is slightly larger than the outer diameter of the composite inner shaft 116. The shell 202 may be wound with a single diameter and then machined to final size or wound with two or more different diameters and then machined to final size. The inner shaft 116 can then be inserted into the hollow core of the formed shell 202, with a small gap between the outer surface of the inner shaft 116 and the inner surface of the formed shell 202. For example, the small gap can be about 0.005″-0.010″ of an inch but can vary depending on the adhesive used. Adhesive can then be used to secure the inner shaft 116 to the interior of the formed shell 202, to prevent the two from separating during machining. The combination inner shaft 116 and shell 202 can then be machined to form the first and second bores 230, 240, as shown in FIG. 11. In use, the ball plugs located in the first and second bores prevent pressure from passing through the gap between the inner shaft and the shell, occupied with cured adhesive or epoxy. In use, the inner shaft 116 supports the two ball plugs at the two bores 230, 240 to resist potential ball plug extrusion due to the high downhole pressure, which can be upwards of around 10,000 psi.

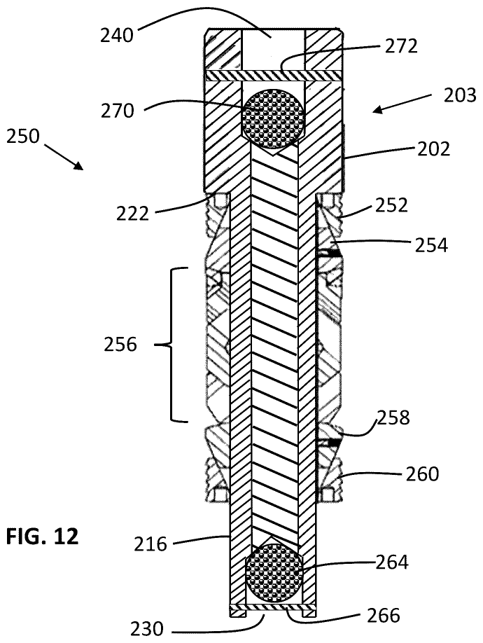

With reference now to FIG. 12, a bridge plug 250 is shown comprising the bridge plug frame 203 described herein and setting components located at the first machined section 216 of the bridge plug frame. In an example, the setting components comprises an upper slip ring 252, an upper wedge element or upper slip wedge 254, a seal portion or seal element 256, a lower wedge element or lower slip wedge 258, and a lower slip ring 260, which can be conventional. The bridge plug can be advanced to a desired location within a well and then set to sealingly engage the interior of the well. To set the bridge plug 250, the engagement portion typically is longitudinally compressed. The slip wedges have an inclined wedge surface, and thus compression of the engagement portion results in each slip wedge urging the associated slip ring radially outwardly and into engagement with the well casing so as to mechanically engage the well casing and hold the plug in position. The seal portion, when longitudinally compressed, deforms radially to engage and establish a seal with the well casing.

A first ball plug 264 is located in the first bore 230 and held therein by a pin 266. A second ball plug 270 is located in the second bore 240 and held therein by a pin 272. After the bridge plug 250 is set within the well and the sealing element 256 sealed against the well casing, pressure above and below the bridge plug forces the first ball plug 264 to seal against the seal seat at the first bore 230 and the second ball plug 270 to seal against the seal seat at the second bore 240.

In general, for bridge plug applications, a single continuous wound, such as a single solid rod, to form the composite preform assembly similar to that of FIG. 10 can be formed. For example, a single solid shaft 116 can have an OD big enough to function as a solid rod to serve as a bridge plug. However, a thick wall part will likely have delamination problems through the thick wall. Thus, by winding the internal solid shaft 116 and the composite preform 200 separately, two relatively thinner wall parts are formed that can then be assembled, which can drastically minimize the possibility of leak due to delamination. However, when assembling two components, the interface between the solid shaft 116 and the preform 200 presents a mostly likely leak path. Thus, by using the ball plugs 264, 270 (FIG. 12) as described, the interface path can be sealed by the ball plugs. Thus, in an example, the solid shaft 116 is half cured, also referred to as just passed the gel stage, and then the composite preform 200 is wound on top of the unprocessed solid shaft 116, the process saves time and effort to create a much stronger adhesion between the two components with some mechanical bonding since the unfinished, rough, surface of the solid shaft 116 at the interface will facilitate bonding as the first layers of the preform 200 is wound thereon. To get past a gel stage, it is usually ⅓ to ¼ of a full cure.

Composite shafts or rods and methods of making and of using the composite shafts or rods and components thereof are within the scope of the present invention. Composite bridge plug frames and methods of making and of using bridge plug frames and components thereof are within the scope of the present invention. Bridge plugs and methods of making and of using bridge plugs and components thereof are within the scope of the present invention.

Although limited embodiments of the winding assemblies and their components for forming composite shafts or rods without a mandrel and bridge plug frames and bridge plugs utilizing the composite shafts have been specifically described and illustrated herein, many modifications and variations will be apparent to those skilled in the art. Accordingly, it is to be understood that the winding assemblies and their components and products formed thereby, including solid composite shafts and composite bridge plug and composite bridge plug frames using the solid composite shafts constructed according to principles of the disclosed devices, systems, and methods may be embodied other than as specifically described herein. The disclosure is also defined in the following claims.

What is claimed is:

1. A method for forming a composite rod or shaft comprising:
suspending roving strands between two spindles to form suspended roving strands that define a composite core; and
winding roving materials through at least two payout eyes and then laying the roving materials around the composite core.

2. The method of claim 1, further comprising adjusting a tension on the suspended roving strands prior to the winding step.

3. The method of claim 1, wherein the at least two payout eyes are located on a frame of an eye unit.

4. The method of claim 3, further comprising a third payout eye located on the frame of the eye unit.

5. The method of claim 4, wherein the at least two payout eyes and the third payout eye are generally evenly spaced relative to one another.

6. The method of claim 2, further comprising winding a plurality of layers of roving materials around the filament core to a desired diameter.

7. A preform comprising a solid composite shaft and a composite shell wound around an exterior of the solid composite shaft.

8. A bridge plug frame comprising a solid composite shaft and a composite shell located around an exterior of the solid composite shaft, a first bore at a first end of the bridge plug frame, and a second bore at a second end of the bridge plug frame; and wherein each of the first bore and the second bore comprises a ball seat having a surface formed by both the solid composite shaft and the composite shell.

9. The bridge plug frame of claim 8, further comprising at least one machined portion and wherein bridge plug components are located at the at least one machined portion.

10. A method of forming a bridge plug comprising:
forming a composite solid shaft without a mandrel; and
locating the composite solid shaft within a composite bridge plug shell.

11. The method of claim 10, further comprising placing bridge plug components onto the bridge plug shell.

12. The method of claim 11, wherein the bridge plug components include a slip ring and a slip wedge.

13. A bridge Plug that consists of 2 balls Plug one on each end.
